(19) United States
(12) Patent Application Publication
(10) Pub. No.: US 2012/0065995 A1
(43) Pub. Date: Mar. 15, 2012

(54) SYSTEM AND METHOD FOR PROVIDING ELECTRONIC RECORDS

(75) Inventors: Charanjit SINGH, Bridgewater, NJ (US); Mukesh Sehgal, Long Valley, NJ (US)

(73) Assignee: Sequent, Inc., Morristown, NJ (US)

(21) Appl. No.: 12/881,711

(22) Filed: Sep. 14, 2010

(51) Int. Cl. G06Q 50/00

(52) U.S. Cl. 705/3

(57) ABSTRACT

Provided is a system and method for storing by an originating server database an originating electronic medical record of at least one patient; extracting by an originating server processor the originating electronic medical record of the at least one patient from the database; transmitting by the originating server processor the originating electronic medical record of the at least one patient; receiving by a health records server processor the originating electronic medical record of the at least one patient; consolidating by the health records server processor the originating electronic medical record of the at least one patient with an existing electronic medical record of the at least one patient, said existing electronic medical record of the at least one patient being a consolidation of a plurality of originating electronic medical records of the at least one patient from a plurality of originating servers; storing by the health records server processor in a health records server database the merged electronic medical record in the health records server database; and providing by the health records server processor to a user access to an electronic medical record of a patient via at least one wireless network.

### BACKGROUND OF THE INVENTION

1. Field of the Invention

This disclosure relates to providing electronic records, and more particularly to a system and method for consolidating electronic medical records and accessing the consolidated electronic medical records through a mobile electronic device.

2. Description of the Related Art

Access to medical records of a patient is a vital need for a treating physician. A treating physician can access the medical records he or she has produced for a patient. Treating physicians are required to contact other physicians to request paper copies of medical records the other physicians produced for a patient. With the advent of electronic transmission of documents, e.g. facsimile and e-mail, the process has been simplified to the extent that the records can be transmitted electronically. Even with this simplification, the treating physician is still required to contact each of the patient's other physicians to request transmission of the records. With the onset of patient confidentiality laws, this process has been encumbered by further layers of processing in that medical record releases are required from each patient and must be received by the other physicians before the medical records can be released.

Electronic Medical Records (EMRs) and Electronic Health Records (EHRs) are now taking hold as a replacement for paper records. EMRs and EHRs are medical and health records that are stored in electronic form. A treating physician can create an electronic version of a patient's medical record and store the electronic records in a database on a computer system maintained by the treating physician. The database can also be hosted by outside vendors, which can be accessed by the treating physicians through secure networks. In addition, many hospitals maintain separate EMRs of their patients.

With the advent of the Internet and mobile communications, a treating physician who created a particular EMR can access that EMR through the Internet and/or via a mobile device, e.g. a Personal Digital Assistant (PDA), smart phone or digital tablet. Although this allows a treating physician access to EMRs that he or she created, the treating physician is required to separately request access to other EMRs created by other physicians or maintained by a hospital. For example, a treating physician must separately enter a username and password for each of the other EMRs. Once access is granted to the other EMRs, the treating physician is required to also separately access each of the databases containing the electronic medical records. For example, a treating physician must first request access to another EMR and then review that EMR, and if a further EMR is needed, the treating physician must again request access to that further EMR and then review that EMR. This process of requesting access and accessing the other EMRs is both time consuming and an interactively intense process required by the treating physician.

These processes are both time consuming and inconvenient for the treating physician and other health care providers. In addition, these processes may result in certain medical records of a patient being overlooked.

### SUMMARY OF THE INVENTION

Accordingly, the present invention has been made to solve at least the above-mentioned problems occurring in the prior art, and an object of the present invention is to provide a system for providing an electronic medical record of a patient. The system includes at least one originating server, including an originating server database effective to store an originating electronic medical record of at least one patient; and an originating server processor effective to extract the originating electronic medical record of the at least one patient from the database, and transmit the originating electronic medical record of the at least one patient; a health records server, including a health records server database effective to store electronic medical records of a plurality of patients; and a health records server processor effective to receive the originating electronic medical record of the at least one patient, consolidate the originating electronic medical record of the at least one patient with an existing electronic medical record of the at least one patient, store the consolidated electronic medical records in the health records server database, and provide to a user access to an electronic medical record of a patient via at least one wireless network; and a data engine effective to convert the originating electronic medical records of the at least one patient into a format compatible with a format of the health records server database.

A further object of the present invention is to provide a method for providing an electronic medical record of a patient. The method includes storing by an originating server database an originating electronic medical record of at least one patient; extracting by an originating server processor the originating electronic medical record of the at least one patient from the database; transmitting by the originating server processor the originating electronic medical record of the at least one patient; receiving by a health records server processor the originating electronic medical record of the at least one patient; consolidation by the health records server processor the originating electronic medical record of the at least one patient with an existing electronic medical record of the at least one patient; storing by the health records server processor in a health records server database the consolidated electronic medical record in the health records server database; and providing by the health records server processor to a user access to an electronic medical record of a patient via at least one wireless network.

### BRIEF DESCRIPTION OF THE DRAWINGS

The accompanying drawings, referred to herein and constituting a part hereof, illustrate the preferred embodiments of the bearing assembly of the present invention and, together with the description, serve to explain the principles of the invention.

FIG. 1 is a diagram illustrating a system for consolidating and accessing electronic records according to an embodiment of the present invention.

FIG. 2 is a diagram illustrating the data flow of a system for consolidating and accessing electronic records according to FIG. 1.

FIG. 3 is a flowchart illustrating a method for consolidating electronic records according to an embodiment of the present invention.

FIG. 4 is a flowchart illustrating a method for accessing electronic records according to an embodiment of the present invention.

FIG. 5 is a diagram illustrating patient level data according to an embodiment of the present invention.

FIG. 6 is a diagram illustrating patient visit level data according to an embodiment of the present invention.

### DETAILED DESCRIPTION OF PREFERRED EMBODIMENTS

Various embodiments of the invention are described hereinafter with reference to the figures. Elements of like structures or function are represented with like reference numerals throughout the figures. The figures are only intended to facilitate the description of the invention or as a guide on the scope of the invention. In addition, an aspect described in conjunction with a particular embodiment of the invention is not necessarily limited to that embodiment and can be practiced in conjunction with any other embodiments of the invention.

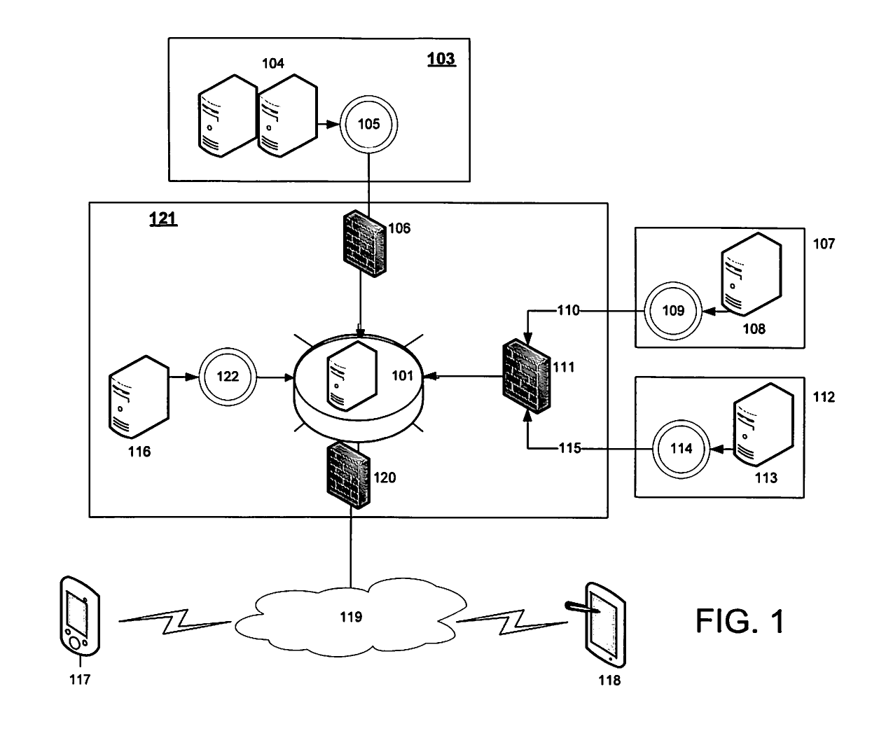

FIG. 1 is a diagram illustrating a system for consolidating and accessing electronic records according to an embodiment of the present invention. Referring to FIG. 1, health records server 101 for storing Electronic Medical Record (EMR) data of multiple patients and multiple physicians is located in a secure data center 121. Hospital EMR server 116 for storing EMR data of patients in a hospital is shown connected to health records server 101 through hospital EMR data engine 122. Hospital EMR server 116 is shown located in the secure data center 121, and as such, no intermediate security barrier, e.g. a firewall, is required. Hospital EMR server 116 can be located outside of secure data center 121. EMR-A vendor data center 103 includes server(s) 104 for storing EMR data on multiple patients of multiple physicians and EMR-A data engine 105. A processor (not separately shown) for controlling EMR-A vendor data center 103 and EMR-A data engine 105 is included in server(s) 104. EMR vendor data center 103 is connected to health records server 101 through firewall 106 for preventing unauthorized access to health records server 101. Firewall 106 is shown located in secure data center 121.

Physician hosted EMR-B 107 include server 108 for storing EMR data of patients of physician B, and includes EMR-B data engine 109. A processor (not separately shown) for controlling physician hosted EMR-B 107 and physician hosted EMR-B data engine 109 is included in server 108. Physician hosted EMR-C 112 include server 113 for storing EMR data of patients of physician C, and includes EMR-C data engine 114. A processor (not separately shown) for controlling physician hosted EMR-C 107 and physician hosted EMR-C 112 is included in server 113. Each of physician hosted EMR-B 107 and physician hosted EMR-C 112 is connected to health records server 101 through firewall 111. A secure Virtual Private Network (VPN) can be used to connect a physician hosted EMR to health records server 101. Other secure networks are contemplated.

Also shown in FIG. 1 are smart phone device 117 and electronic tablet 118 for accessing EMR data stored on health records server 101. Smart phone device 117 and electronic tablet 118 can connect to health records server 101 through wireless network 119 and firewall 120. Although a HyperText Transfer Protocol Secure (HTTPS) based network is contemplated for the wireless network 119, other known networks, for example, Secure Sockets Layer (SSL) protocol, can be utilized. The use of secure networks provides a high level of encryption and authenticity of connecting networks. Other electronic devices to access EMR data stored on health records server 101 are contemplated.

Although separate firewalls 106, 111 and 120 are illustrated in FIG. 1, other embodiments are contemplated. For example, all unsecure traffic can be routed through a single firewall. The use and number of firewalls can vary with system design.

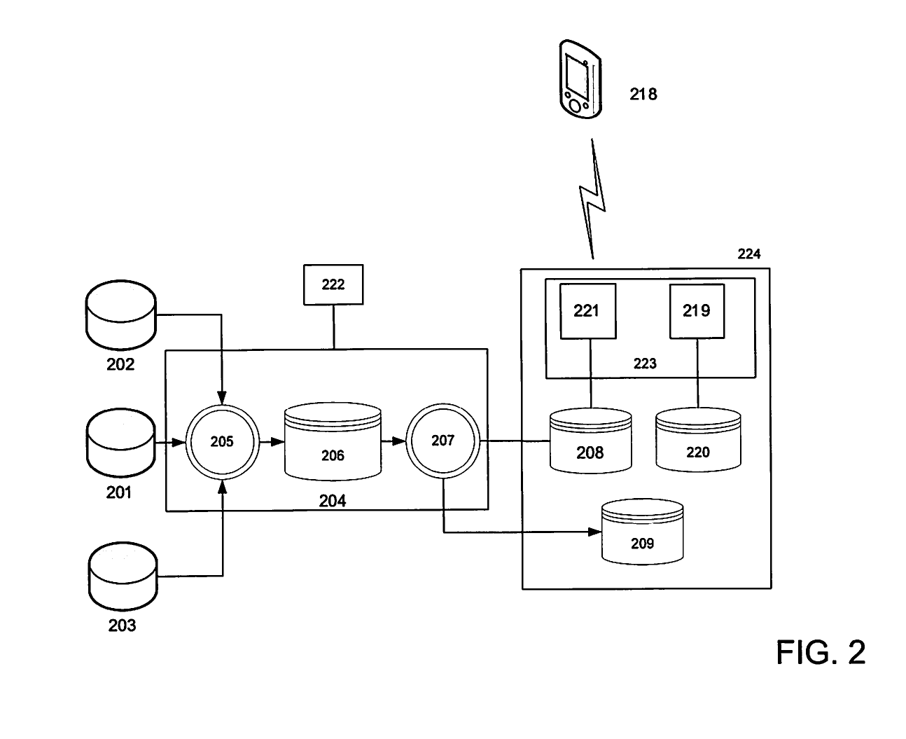

FIG. 2 is a diagram illustrating the data flow of a system for consolidating and accessing electronic records according to FIG. 1. Under control of processor 222, data engine EMR-A 204 can be directed to extract at 205 EMR data from EMR-A physician 1 database 201, EMR-A physician 2 database 202, and EMR-A physician 3 database 203. The extracted EMR data can be loaded into staging database EMR-A 206. The data from staging database EMR-A 206 can be converted at transform EMR-A 207 into a format compatible with the format of health records server 224. The converted EMR data can be sent to health records server 224. Health records server 224, under control of processor 223, can store the converted EMR data in database 208. Although illustrated as occurring at transform EMR-A 207, the conversion of the EMR data into a format compatible with health records server 224 can take place within the health records server 224. Processor 222 can direct transform EMR-A 207 to add a unique identifier to the EMR data to identify the database from which the data has originated. The unique identifier can be used to identify to the treating physician accessing the EMR data the source of the EMR data.

The process described above can be preformed at regular update intervals such that the EMR data stored in database 208 is current and accurate. For example, the update interval can be triggered based on a time interval, e.g. every 8 hours, or can be triggered when EMR data contained in a physician database is modified. A combination of both a time interval trigger and a modification trigger can be used. In addition, the updates can be full updates or incremental updates depending on the design of the system.

Back-up database 209 is also shown in FIG. 2. All EMR data stored in database 208 can also be stored in back-up database 209. Back-up database 209 can be used to perform load balancing and data recovery.

Health records server 224 receives EMR data from all similarly situated EMRs, e.g. physician hosted EMRs and/or hospital EMRs (as shown in FIG. 1), which are to have EMRs stored in health records server 224. Database 209 can be used as a disaster recovery database and can therefore be hosted on a separate physical server.

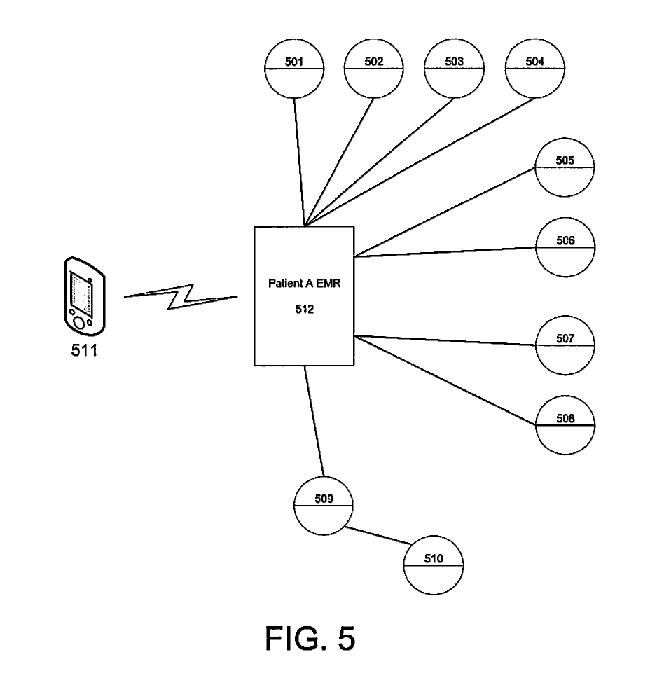

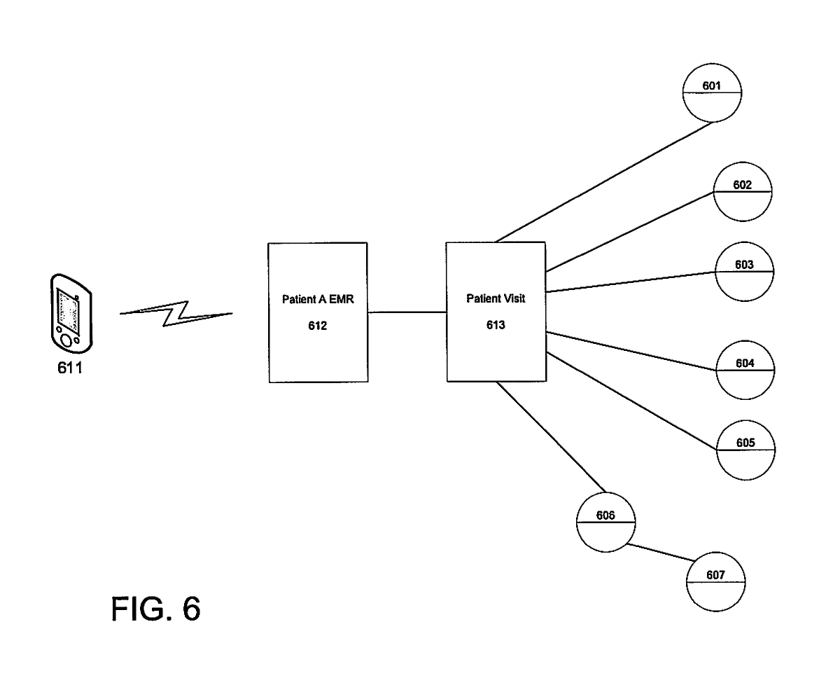

Health records server 224 can receive EMR data from several databases. In order to present the EMR data collected from the several databases in an orderly and easy to read format, the EMR data can be consolidated with existing EMR data and/or organized in various structures. In order to facilitate this process, the EMR data extracted from the various databases must be formatted such that it can be consolidated with existing EMR data. For example, EMR data for patient A from EMR-A physician 1 database 201 can be consolidated with EMR data for patient A from hospital EMR database 116 in order for all of the EMR data of patient A to be orderly and easily accessible by the treating physician. Formatting the EMR data into a uniform structure simplifies the consolidation process. Thus, prior to the consolidation process, the EMR data from the various databases can be formatted into the uniform structure. One such structure can include fields for a patient's profile such as: NAME, SOCIAL SECURITY NUMBER, ADDRESS, PHONE NUMBER, EMAIL ADDRESS, DATE OF BIRTH, EMERGENCY CONTACT, ALLERGIES, PHARMACIES USED; fields for diagnosis and drug history such as: DIAGNOSIS HISTORY, PRESCRIPTION INFORMATION, OVER THE COUNTER DRUGS; observation and disease information such as: PROCEDURES, LAB RESULTS, TEST RESULTS (e.g. height, weight), DISEASES, SYMPTOMS; fields for survey questions and answers such as: SMOKER, ALCOHOL USER. Dates and times can be associated with the fields to indicate when the information was created and/or modified. An ORIGINATING EMR DATABASE IDENTIFIER field can also be included. Further examples of the structure will be described with reference to FIGS. 5 and 6, below. Other structures and/or fields are contemplated.

Accessing the data stored in health records server 224 requires both authentication and content rendering. One embodiment of the present invention can utilize a voice recognition authentication 219, performed in processor 223, to allow access by a treating physician to the medical records stored in database 208 of health records server 224. One such voice recognition authentication is disclosed in co-pending U.S. patent application Ser. No. ______, filed on Sep. 14, 2010, and entitled “System And Method For Providing Group Discussions” the contents of which are hereby incorporated by reference. Other secure authentication processes are contemplated.

In order to perform voice recognition authentication 219, a voice pattern of a treating physician of a word or phrase is stored in voice registration database 220. The name or other identifier of the treating physician can be stored with the voice pattern for later use for identifying the treating physician, indexing EMR data and/or EMR data access and look-up. Prior to being granted access to the EMR data stored in health records server 208, the treating physician using smart phone device 218 can perform voice recognition authentication 219. Voice recognition authentication 219 requires treating physician to speak a prearranged word or phrase, a voice pattern of which is stored in voice registration database 220. The prearranged question, word or phrase can be changed on a regular basis to add an extra level of security. The voice pattern of the word or phrase spoken by the treating physician is compared with a voice pattern of the word or phrase stored in voice registration database 220. If the voice pattern stored in voice registration database 220 matches the voice pattern of the word or phrase spoken by the treating physician, the treating physician is granted access to the EMR data stored in health records server 208. If the voice pattern of the word or phrase stored in voice registration database 220 does not match the voice pattern of the word or phrase spoken by the treating physician, the treating physician is denied access to the EMR data stored in health records server 208. Although shown as separate databases, database 208 and database 220 can be included in one database.

If access to the EMR data stored in health records server 208 is granted, content rendering 221 is preformed by processor 223. Content rendering 221 identifies the type of smart phone device 218 the treating physician is using to access the EMR data and formats the data to be viewed on a display of the smart phone device 218 the treating physician is using to access the EMR data.

In general, when one electronic device accesses another electronic device, information identifying the types of electronic devices is transmitted between the electronic devices. Once the type of electronic device is known, data can be formatted for viewing on the accessing electronic device. For example, if a cellular telephone, as an accessing electronic device, accesses a web page located on the Internet, the web server on which the web page is located can identify the type of device as a cellular telephone and format the web page for viewing on the screen of the cell phone. This formatting is required due to the different sizes in displays on different types of electronic devices. For example, a display of cellular telephone is much smaller and has different dimensions than a display on a personal computer, and thus requires different formatting to properly view the web page. This transmission of information identifying the types of electronic devices and use of the information of identifying the type of device to format data for viewing is well known in the art of electronic communications.

Returning again to FIG. 2, based on the type of smart phone device 218, content rendering 221 can format the EMR data to be viewed on smart phone device 218 and can transmit the EMR data to smart phone device 218 for viewing by the treating physician. At this point, the EMR data transferred from EMR-A physician 1 database 201, EMR-A physician 2 database 202, and EMR-A physician 3 database 203 is transmitted to smart phone device 218 for display.

In an embodiment of the present invention, access to the EMR data stored in database 208 is limited to only the patients of the treating physician. That is, not all physicians accessing the EMR data will have access to all of the EMR data. For example, EMR data from EMR-A physician 1 database 201 may contain EMR data on patient A and patient B. If patient A is also a patient of the treating physician accessing the EMR data stored in database 208 but patient B is not, the treating physician will only be granted access to the EMR data of patient A and not the EMR data of patient B. In order to perform this limitation process, each physician that wishes to access the EMR data stored in health records server 224 can provide a physician patient list identifying patients of that physician. The physician patient list can be stored in database 208. Processor 223 can access the physician patient list to determine the patient EMR data each physician can access. If a patient is on a physician patient list, that physician can be granted access to that patient's EMR data; if not, access can be denied. If a patient is being treated by multiple physicians, each of the physicians will have access to the records for that patient.

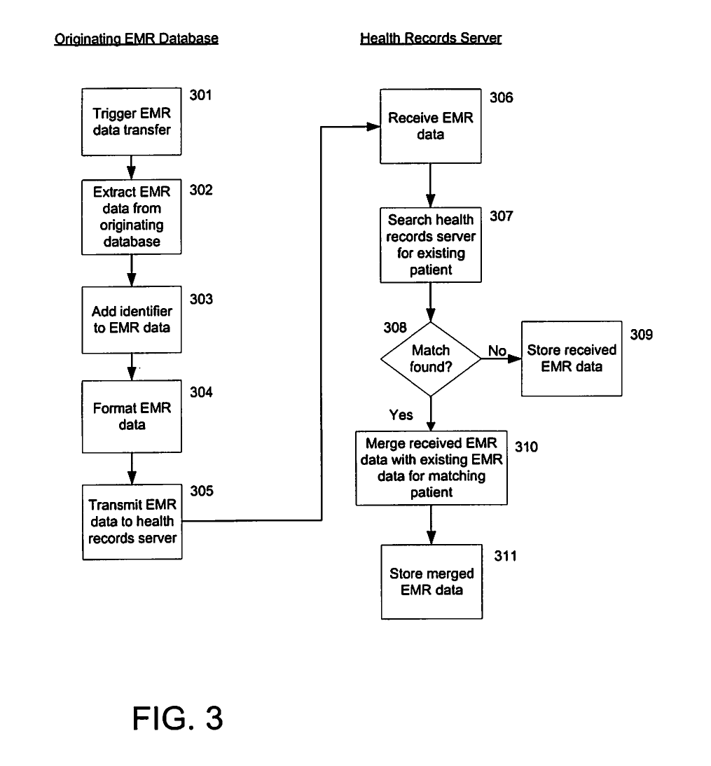

FIG. 3 is a flowchart illustrating a method for consolidating electronic records according to an embodiment of the present invention. Referring to FIGS. 1 and 3, in step 301, an EMR data transfer is triggered in physician hosted EMR-B 107 as an originating EMR database. In step 302, EMR-B data engine 109 can extract EMR data from physician hosted EMR-B 107. In step 303, EMR-B data engine 109 can add an identifier to the extracted EMR data to identify physician hosted EMR-B 107 as the originating EMR database. Any unique identifier can be used. In step 304, EMR-B data engine 109 can format the identified EMR data for consolidation. In step 305, physician hosted EMR-B 107 can transmit the formatted EMR data to health records server 101.

In step 306, health records server 101 can receive the formatted EMR data. In steps 307 and 308, health records server 101 can search its database and determine if a patient contained in the received EMR data exists in the EMR records already stored in health records server 101. The match can be based on the information contained in one or more patient profile fields, or other uniquely identifying data. If no match is found, in step 309, health records server 101 stores the received EMR data as new patient data. If a match is found, in step 310, health records server 101 can merge the received EMR data with the existing EMR data for the existing patient. In step 311, health records server 101 can store the merged EMR data. The consolidation process allows for the display of records of a patient received from two different EMR systems.

In the process of FIG. 3, the order of performing steps 303 and 304 can be reversed. Similar processes are performed for each EMR database whose EMR data is to be consolidated in health records server 101.

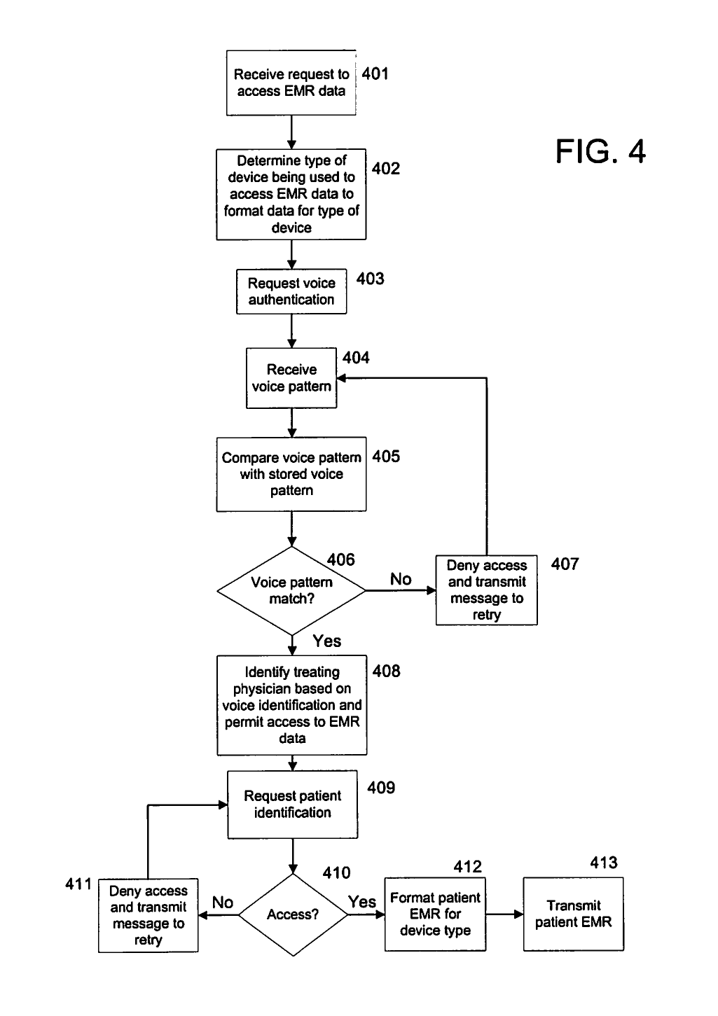

FIG. 4 is a flowchart illustrating a method for accessing electronic records according to an embodiment of the present invention. In step 401, health records server 101 can receive a request to access the EMR data contained in health records server 101. In step 402, health records server 101 can determine the type of device being used to access EMR data for use in the formatting of the EMR data for display on that type of device. In step 403, health records server 101 can request voice authentication from a user of the device, e.g. a treating physician, requesting access to the EMR data contained in health records server 101. In step 404, health records server 101 can receive a voice pattern from the treating physician of the prearranged word or phrase stored in the voice recognition database 220. In step 405, health records server 101 can compare the received voice pattern with stored voice patterns and in step 406 can determine if there is a match. If no match is found, in step 407, health records server 101 can deny access to the EMR data and transmit a message to the treating physician to reattempt voice recognition, and return to step 404. If a match is found, health records server 101 can identify the treating physician based on the voice recognition and permit access to the EMR data.

In step 409, health records server 101 can request the user to identify a patient whose EMR data is to be accessed. Several methods of identifying a patient are contemplated. As one option, health records server 101 can provide the user with a list of patients' names that the user is permitted to access. The list can be based on a physician patient list supplied by a treating physician as described above. The treating physician can select a patient from the list to continue the process. As another option, health records server 101 can provide the treating physician with a graphical user interface (GUI) into which the treating physician can enter identifying information of a patient, e.g. patient's name or social security number, and transmit the identifying information to health records server 101. Health records server 101 can look-up the patient in the in the health records server 101 and cross-reference the patient with the physician patient list. Other options are contemplated. Whichever option is used, health records server 101 determines, in step 410, if access should be granted to the treating physician. If access is denied, in step 411, health records server 101 can transmit a message to the treating physician to retry the patient identification, and return to step 409.

If in step 410 access is granted to the EMR data of the identified patient, in step 412, health records server 101 can format the EMR data of the identified patient for the type of device determined in step 402, and in step 413, can transmit the EMR data of the identified patient to be displayed on the device of the treating physician.

The display of the patient's EMR data on the device of the treating physician can be structured to suit the needs of the treating physician. One such structure is patient level data, an example of which is illustrated in FIG. 5. Another such structure is patient visit level data, an example of which is illustrated in FIG. 6. Other formats are contemplated.

The structure in FIG. 5 is centered on the patient. Treating physician, through smart phone device 511, accesses patient A EMR data 512. Patient A EMR data 512 is displayed to provide a patient profile for patient A. The patient profile can include information such as for example contact details 501 (e.g. address, telephone numbers, email addresses, etc.), emergency contacts 502, allergies 503, pharmacies used 504, diagnosis history 505 (e.g. start and end dates, notes, etc.), drug history 506 (e.g. names of drugs, start and end dates, prescription details, etc.), observations 507 (e.g. notes, flowcharts, procedures, lab results, time sensitive metrics (e.g. blood test results, weight, drug delivery, etc.)), diseases 508 (e.g. symptoms, dates and times, etc.), and surveys including questions 509 and answers 510. Other information can be included.

The structure in FIG. 6 is centered on the visit history of a patient. Treating physician, through smart phone device 611, accesses patient A EMR data 612. Patient A EMR data 612 is displayed to provide a visit profile for patient A. The visit profile can include information such as for example visit details 613 (e.g. location, date and time of visit, physician, etc.), details of chief complaint 601, history of present illness 602, review of symptoms 603, physical examination details 604, diagnosis 605, medications 606 and prescription details 607. Other information can be included.

As can be seen, the present invention can provide a treating physician with patient EMR data in an orderly and convenient format. In doing so, a treating physician can save time and provide better services to patients.

While the invention has been described with reference to a number of exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to any particular exemplary embodiment disclosed herein.

What is claimed is:

1. A system for providing an electronic medical record of a patient, comprising:
at least one originating server, comprising:
an originating server database effective to store an originating electronic medical record of at least one patient; and
an originating server processor effective to extract the originating electronic medical record of the at least one patient from the database, and transmit the originating electronic medical record of the at least one patient;
a health records server, comprising:
a health records server database effective to store electronic medical records of a plurality of patients; and
a health records server processor effective to receive the originating electronic medical record of the at least one patient, consolidate the originating electronic medical record of the at least one patient with an existing electronic medical record of the at least one patient, store the consolidated electronic medical record in the health records server database, and provide to a user access to an electronic medical record of a patient via at least one wireless network; and
a data engine effective to convert the originating electronic medical records of the at least one patient into a format compatible with a format of the health records server database.

2. The system of claim 1, wherein the data engine is contained in one of the at least one originating server and the health records server.

3. The system of claim 1, wherein the health records server processor is further effective to authenticate the user prior to providing to the user the access to the electronic medical record of the patient.

4. The system of claim 3, wherein the health records server processor is effective to authenticate the user prior to providing to the user access to the electronic medical record of the patient by being effective to perform a voice authentication of the user.

5. The system of claim 1, wherein an electronic medical record of the at least one patient does not exist in the health records server database, and the health records server processor is further effective to store the originating electronic medical records of the at least one patient in the health records server database.

6. The system of claim 1, where the user accesses the electronic medical record of the patient via the at least one wireless network via an electronic handheld device.

7. The system of claim 6, wherein the health records server processor is further effective to determine a type of the electronic handheld device and format the electronic medical record of the patient for display on the determined type of the electronic handheld device.

8. The system of claim 1, wherein the health records server processor is further effective to receive an identifier of a patient and provide to the user the access to the electronic medical record of the identified patient.

9. The system of claim 8, wherein the health records server processor is further effective to transmit a list of patients to the user and receive the identifier associated with a patient selected from the list of patients.

10. The system of claim 1, wherein the health records server processor is further effective to deny access to the electronic medical record of the patient if the user is not authorized to access the electronic medical record of the patient.

11. A method for providing an electronic medical record of a patient, comprising the steps of:
storing in an originating server database an originating electronic medical record of at least one patient;
extracting by an originating server processor the originating electronic medical record of the at least one patient from the database;
transmitting by the originating server processor the originating electronic medical record of the at least one patient;
receiving by a health records server processor the originating electronic medical record of the at least one patient;
consolidating by the health records server processor the originating electronic medical record of the at least one patient with an existing electronic medical record of the at least one patient, said existing electronic medical record of the at least one patient being a consolidation of a plurality of originating electronic medical records of the at least one patient from a plurality of originating servers;
storing by the health records server processor in a health records server database the consolidated electronic medical record in the health records server database; and
providing by the health records server processor to a user access to an electronic medical record of a patient via at least one wireless network.

12. The method of claim 11, wherein the originating electronic medical record of the at least one patient is converted, by one of the at least one originating server and the health records server, into a format compatible with a format of the health records server database.

13. The method of claim 11, further comprising authenticating the user prior to providing to the user the access to the electronic medical record of the patient.

14. The method of claim 13, wherein the authentication of the user is performed via a voice authentication of the user.

15. The method of claim 11, further comprising storing the originating electronic medical records of the at least one patient in the health records server database when an electronic medical record of the at least one patient does not exist in the health records server database.

16. The method of claim 11, where the user accesses the electronic medical record of the patient via the at least one wireless network via an electronic handheld device.

17. The method of claim 16, further comprising determining a type of the electronic handheld device and formatting the electronic medical record of the patient for display on the determined type of the electronic handheld device.

18. The method of claim 11, further comprising receiving from the user an identifier of a patient and providing to the user the access to the electronic medical record of the identified patient.

19. The method of claim 18, further comprising transmitting a list of patients to the user and receiving the identifier associated with a patient selected from the list of patients.

20. The system of claim 11, denying access to the electronic medical record of the patient if the user is not authorized to access the electronic medical record of the patient.
